(19) United States
(12) Patent Application Publication
(10) Pub. No.: US 2016/0069570 A1
(43) Pub. Date: Mar. 10, 2016

(54) METHOD AND APPARATUS FOR CONDITIONING DIFFUSER OUTLET FLOW

(71) Applicant: Solar Turbines Incorporated, San Diego, CA (US)

(72) Inventors: Christopher Zdzislaw Twardochleb, Alpine, CA (US); Stephen Paul Burke, San Diego, CA (US); Bharat Damodar Raghunathan, San Diego, CA (US); Robert James Fanella, San Diego, CA (US)

(21) Appl. No.: 14/479,010

(22) Filed: Sep. 5, 2014

(51) Int. Cl. F23R 3/10; F02C 9/16; F02C 3/04

(52) U.S. Cl. CPC F23R 3/10; F02C 3/04; F02C 9/16; F23R 2900/00017; F05D 2220/32; F05D 2260/30; F05D 2230/60; F05D 2230/232

(57) ABSTRACT

A diffuser for a gas-turbine engine is provided. The diffuser has an outer housing, an inner housing, and a diffusion plate. The outer housing has a first wall. The inner housing has a second wall and is disposed within the outer housing. A flow passage is formed between the first wall and the second wall and has a forward end and an aft end. The diffusion plate has a plurality of openings and extends across the flow passage from the first wall to the second wall in an aft direction.

### TECHNICAL FIELD

The present disclosure generally pertains to gas turbine engines, and is more particularly directed toward a gas turbine diffuser.

### BACKGROUND

Gas turbine engines include compressor, diffuser, combustor, and turbine sections. The diffuser reduces airflow velocity (conservation of mass) while increasing static pressure (Bernoulli's equation). The diffuser also provides air to the combustor for the combustion reaction. The diffuser assists in the proper control of the combustion process.

U.S. Pre-Grant Pub. No. 2012/0006029 to Bilbao et al. shows a combustor. The combustor includes a first premix main burner, a second premix main burner, and a supply air reversing region upstream of the first and second premix burners. The first premix main burner includes a first swirler airfoil section. The second premix main burner includes a second swirler airfoil section. The first swirler airfoil section and the second swirler airfoil section are intended to impart swirl to a first airflow and a second airflow as the airflows exit the first premix main burner and the second premix main burner, respectfully. This combustor is intended to generate a first airflow volume through the first premix main burner that is different than a second airflow volume through the second premix main burner.

The present disclosure is directed toward overcoming known problems and/or problems discovered by the inventors.

### SUMMARY OF THE DISCLOSURE

In one embodiment of the present application, a diffuser for a gas-turbine engine is provided. The diffuser has an outer housing, an inner housing, and a diffusion plate. The outer housing has a first wall. The inner housing has a second wall and is disposed within the outer housing. A flow passage is formed between the first wall and the second wall and has a forward end and an aft end. The diffusion plate has a plurality of openings and extends across the flow passage from the first wall to the second wall in an aft direction.

In another embodiment of the present application, a gas turbine engine is provided. The gas turbine engine includes a compressor, a turbine and a diffuser. The turbine is located downstream of the compressor. The diffuser is located downstream of the compressor and upstream of the turbine. The diffuser includes a first annular housing, a second annular housing, and a diffusion plate. The first annular housing has a first wall having an inner surface. A forward retainer member extends from the inner surface of the first wall. A forward plate receiving gap is formed between the inner surface of the first wall and the forward retainer member. The second annular housing is disposed within the first annular housing and has a second wall having an outer surface. A flow passage having an upstream end and a downstream end is formed between the first wall and the second wall. An aft retainer member extends from the outer surface of the second wall. An aft plate receiving gap is formed between the inner surface of the second wall and the aft retainer member. The diffusion plate extends across the flow passage from the first wall to the second wall. The diffusion plate has a plurality of openings, an upstream end inserted into the forward plate receiving gap and a downstream end inserted into the aft plate receiving gap.

In another embodiment of the present application, a method of conditioning output of a diffuser upstream of a combustor in a gas turbine engine is provided. The method includes identifying a flow passage between a first wall of the diffuser and a second wall of the diffuser having a forward end and an aft end. The method also includes attaching a diffusion plate having a plurality of openings to the second wall of the diffuser. The method further includes attaching the diffusion plate to the first wall of the diffuser such that the diffusion plate extends across the flow passage from the first wall to the second wall in an aft direction and forms an angle with respect to the second wall.

### BRIEF DESCRIPTION OF THE DRAWINGS

FIG. 1 is a schematic illustration of an example gas turbine engine.

FIG. 2 is a cross-section of an example diffuser of the gas turbine engine.

FIG. 3 is perspective view of a portion of the diffuser.

FIG. 4 is perspective view of a portion of the diffuser.

FIG. 5 is an enlarged view of a portion V of FIG. 2.

FIG. 6 is an enlarged view of a first portion VI of FIG. 5 with the diffusion plate removed.

FIG. 7 is an enlarged view of the first portion VI of FIG. 5 with the diffusion plate installed.

FIG. 8 is an enlarged view of a second portion VIII of FIG. 5.

FIG. 9 is an enlarged view of a forward end of the diffusion plate.

FIG. 10 is an enlarged view of an aft end of the diffusion plate.

FIG. 11 is a flow chart of an exemplary method of conditioning diffuser output upstream of a combustor in a gas turbine engine.

### DETAILED DESCRIPTION

The systems and methods disclosed herein include a gas turbine engine diffuser with a diffusion plate positioned at an oblique angle to a flow passage through the diffuser. In embodiments, the diffusion plate may be configured to alter trajectory of high velocity air entering the combustor case and change flow patterns within the diffuser before entering the injector. Moreover, the diffusion plate may be configured to break up jets of incoming high velocity air to provide a more uniform direct airflow into the injector.

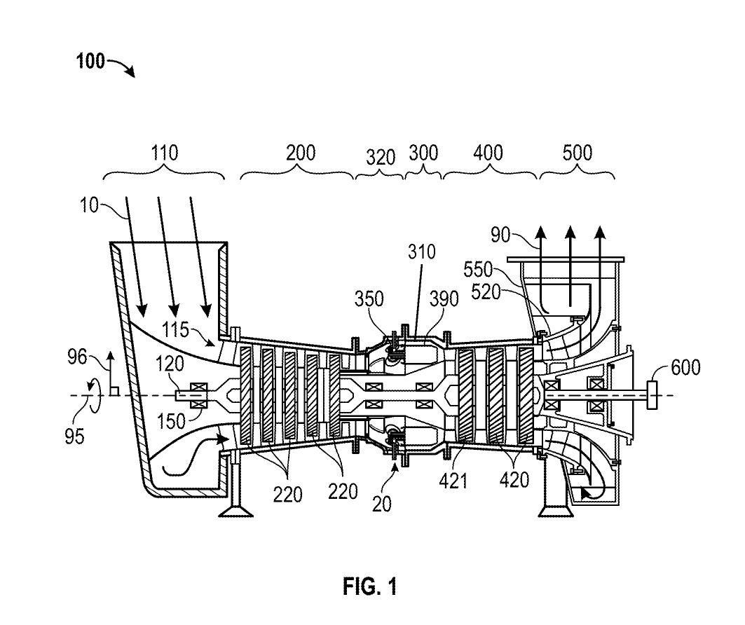

FIG. 1 is a schematic illustration of an exemplary gas turbine engine. Some of the surfaces have been left out or exaggerated (here and in other figures) for clarity and ease of explanation. Also, the disclosure may reference a forward and an aft direction. Generally, all references to “forward” and “aft” are associated with the flow direction of primary air (i.e., air used in the combustion process), unless specified otherwise. For example, forward is “upstream” relative to primary air flow, and aft is “downstream” relative to primary air flow.

In addition, the disclosure may generally reference a center axis of rotation of the gas turbine engine (“center axis” 95), which may be generally defined by the longitudinal axis of its shaft 120 (supported by a plurality of bearing assemblies 150). The center axis 95 may be common to or shared with various other engine concentric components. All references to radial, axial, and circumferential directions and measures refer to center axis 95, unless specified otherwise, and terms such as “inner” and “outer” generally indicate a lesser or greater radial distance from, wherein a radial 96 may be in any direction perpendicular and radiating outward from center axis 95.

Structurally, a gas turbine engine 100 includes an inlet 110, a compressor 200, a diffuser 320, a combustor 300, a turbine 400, an exhaust 500, and a power output coupling 600. One or more of the rotating components are coupled by one or more shafts 120. The compressor 200 includes one or more compressor rotor assemblies 220. The combustor 300 includes one or more injectors 350 and includes one or more combustion chambers 390. The turbine 400 includes one or more turbine rotor assemblies 420. The exhaust 500 includes an exhaust diffuser 520 and, in some cases, an exhaust collector 550 may also be provided. However, in some embodiments, the exhaust collector 550 may be omitted and the exhaust may be directly ejected.

As illustrated, the diffuser 320 is located downstream of the compressor 200 and upstream of the combustor 300. According to one embodiment, the diffuser 320 mechanically interfaces between the compressor 200 and the combustor 300 and is coupled to the combustor case 310. In alternate embodiments, diffuser 320 may be integrated with the compressor 200, with the combustor 300, subdivided, or any combination thereof.

Functionally, a gas (typically air 10) enters the inlet 110 as a “working fluid”, and is compressed by the compressor 200. In the compressor 200, the working fluid is compressed in an annular flow path 115 by the series of compressor rotor assemblies 220. In particular, the air 10 is compressed in numbered “stages”, the stages being associated with each compressor rotor assembly 220. For example, “4th stage air” may be associated with the 4th compressor rotor assembly 220 in the downstream or “aft” direction—going from the inlet 110 towards the exhaust 500). Likewise, each turbine rotor assembly 420 may be associated with a numbered stage. For example, first stage turbine rotor assembly 421 is the forward most of the turbine rotor assemblies 420. However, other numbering/naming conventions may also be used.

Once compressed air 10 leaves the compressor 200, it enters the diffuser 320. The diffuser 320 is configured to diffuse the compressed air 10, and provide the air 10 to one or more injectors 350 and combustor liner in combustion chamber 390. Via the injector 350, air 10 and fuel 20 are injected into the combustion chamber 390 and ignited. After the combustion reaction, energy is then extracted from the combusted fuel/air mixture via the turbine 400 by each stage of the series of turbine rotor assemblies 420. Exhaust gas 90 may then be diffused in exhaust diffuser 520 and collected, redirected, and exit the system via an exhaust collector 550. Exhaust gas 90 may also be further processed (e.g., to reduce harmful emissions, and/or to recover heat from the exhaust gas 90).

One or more of the above components (or their subcomponents) may be made from stainless steel and/or durable, high temperature materials known as “superalloys”. A superalloy, or high-performance alloy, is an alloy that exhibits excellent mechanical strength and creep resistance at high temperatures, good surface stability, and corrosion and oxidation resistance. Superalloys may include materials such as HASTELLOY, INCONEL, WASPALOY, RENE alloys, HAYNES alloys, INCOLOY, MP98T, TMS alloys, and CMSX single crystal alloys.

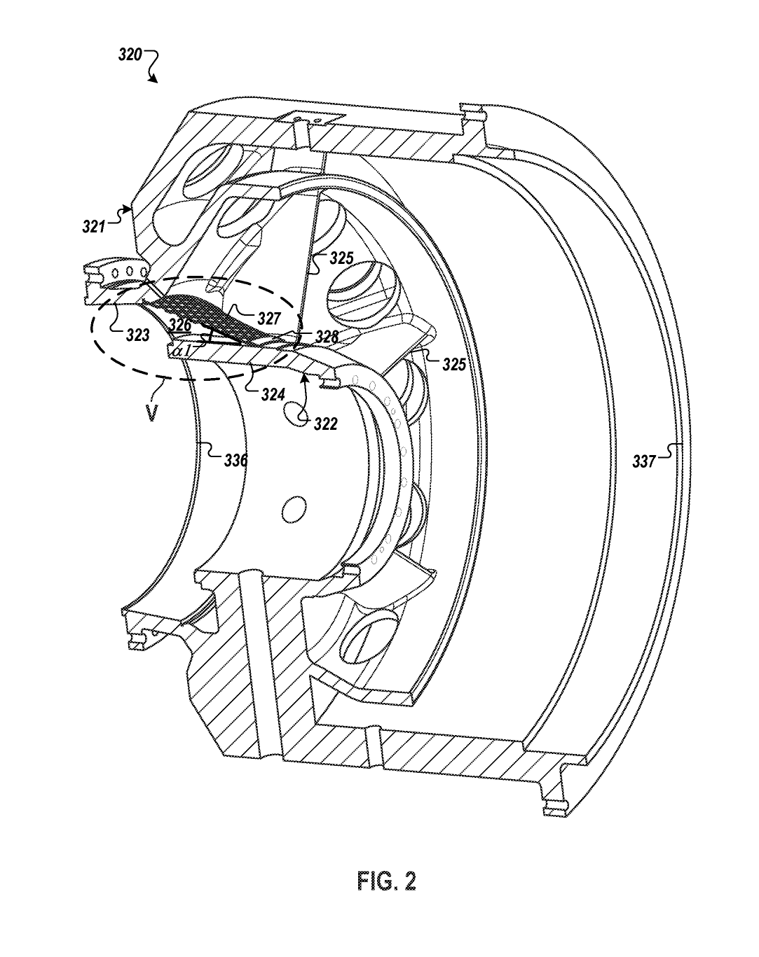

FIG. 2 is a cross-section of an example diffuser 320 of the gas turbine engine 100. The diffuser 320 may be formed by a first (outer) housing 321 having at least a first wall 323. In some embodiments, the outer housing 321 may be a first annular housing having an outward flare along its length. Though FIG. 2 illustrates a cross-section of the diffuser 320, it should be apparent that a symmetrically similar portion to what is illustrated forms the remainder of the diffuser 320, but has been removed for clarity.

As illustrated, the inner radius of the outer housing 321 at the forward (i.e. compressor) side 336 may be less than the inner radius of the outer housing 321 at the aft (i.e. combustor) side 337. A second (inner) housing 322 having at least a second wall 324 is disposed within the outer housing 321. In some embodiments, the inner housing 322 may be a second annular housing. Further, in some embodiments, the inner housing 322 may be supported or connected by one or more struts 325 extending inward from the outer housing 321. The specific configuration of the struts 325 is not particularly limited and may include 3 struts, 5 struts, 7 struts, or any other strut configuration that may be apparent to a person of ordinary skill in the art. Further, in some embodiments the diffuser 320 may not have any struts 325 supporting the inner housing 322. In embodiments not having struts, the diffusion plate 327 may be formed as a single diffusion plate structure having a conical or partially conical shape, as may be apparent to a person of ordinary skill in the art.

A flow passage 326 may be formed between the first wall 323 of the outer housing 321 and the second wall 324 of the inner housing 322. In embodiments of the diffuser 320 having one or more struts 325, the flow passage 326 may be defined between adjacent struts 325. Within the flow passage 326, a diffusion plate 327 may be attached to the first wall 323 and the second wall 324 to extend across the flow passage 326 toward an aft (combustor side) end 337 of the diffuser to form an oblique angle α₁ to the flow passage 326. In some embodiments, the oblique angle al may be in a range between 15° and 45°. The forward or upstream end 332 of diffusion plate 327 extends from or is attached to the first wall 323 and the aft or downstream end 333 of the diffusion plate 327 extends from or is attached to the second wall 324. On the aft side, the diffusion plate 327 is attached to the second wall 324 by an aft retainer member 328. The attachment of the diffusion plate 327 to the first and second walls 323, 324 will be discussed in greater detail below.

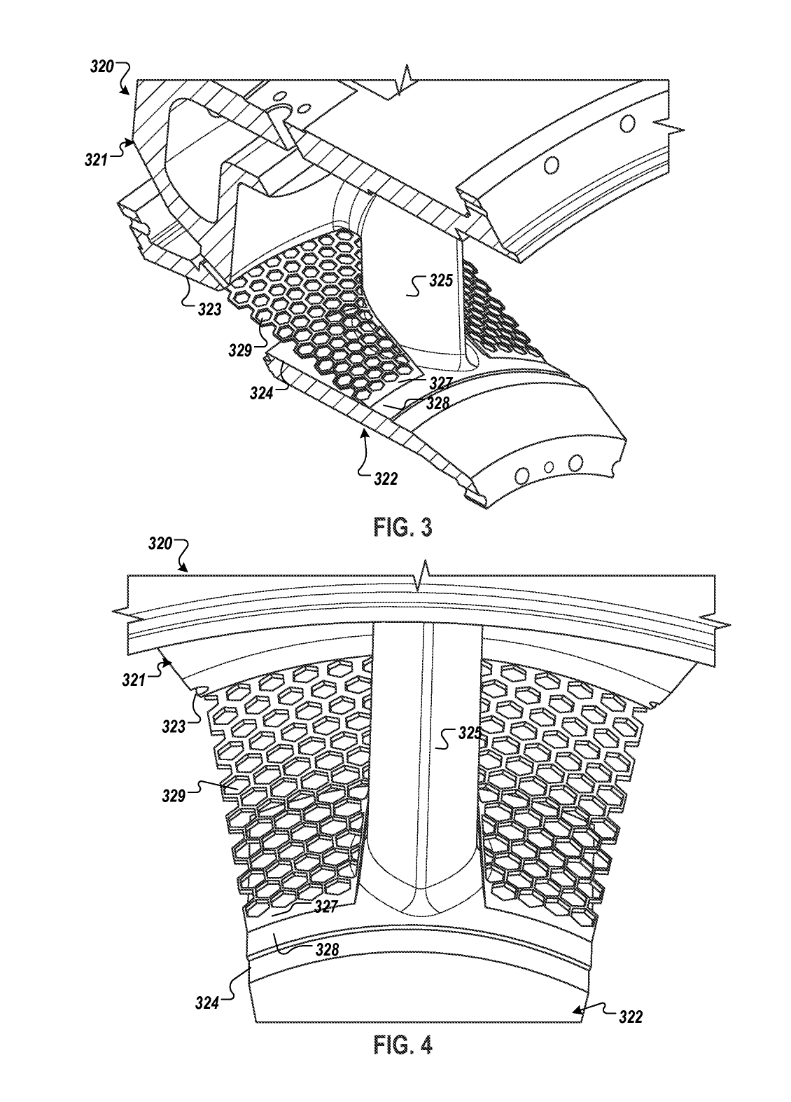

FIGS. 3 and 4 are perspective views of a portion of the diffuser 320. Specifically, FIG. 3 illustrates an elevated side perspective view and FIG. 4 illustrates an aft perspective view looking forward. As illustrated, the diffusion plate 327 is disposed on both sides of the strut 325 and is contoured to wrap around the strut 325. However, embodiments of the present application are not limited to this configuration and may instead be formed as a plurality of separate diffusion plates disposed on opposite sides of the strut 325. The number of diffusion plates is not particularly limited and may be any number of diffusion plates that may be selected by a person of ordinary skill in the art. Further, though described as diffusion plates 327, in some embodiments, the diffusion plates 327 are illustrated having a partially curved structure forming a partially conical diffusion structure. As may be apparent to a person of ordinary skill in the art, the plurality of diffusion plates 327 may collectively form a diffusion cone structure attached to the outer housing 321 and the inner housing 322.

The diffusion plate 327 has a plurality of openings 329 through which air 10 can pass. In some embodiments, the openings 329 may make up 50-60% of the surface area of the diffusion plate 327. However, embodiments of the diffusion plate 327 are not limited to this configuration and may make up more or less of the surface area of the diffusion plate 327. Further, the shape of the openings 329 are not particularly limited, and may include hexagonal shapes, octagonal shapes, circular shapes, square shapes, triangular shapes, or any other shape that may be apparent to a person of ordinary skill in the art.

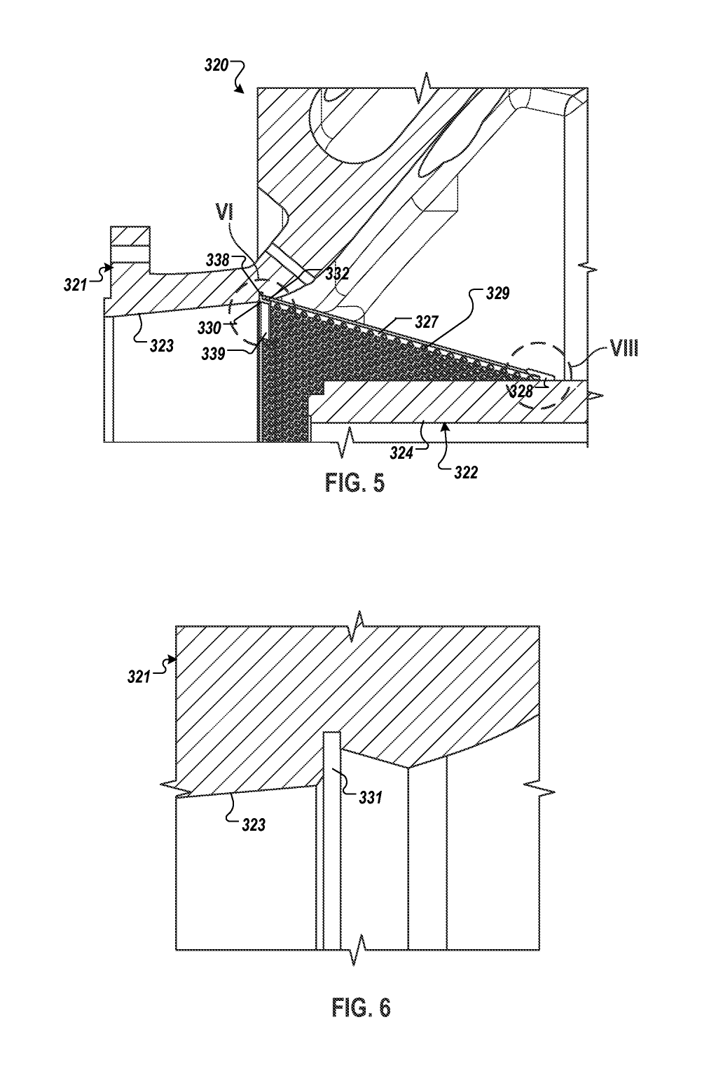

FIG. 5 is an enlarged view of a portion V of FIG. 2. As illustrated the forward end 332 of the diffusion plate 327 is attached to the first wall 323 of the outer housing 321 by a forward retainer member 330. In some embodiments, the forward retainer member 330 may be a plurality of pieces spaced around an inner circumference of the outer housing 321. In other embodiments, the forward retainer member 330 may be formed as a forward retainer ring, or a plurality of forward retainer ring sections that collectively form a forward retainer ring, extending around the inner circumference of the outer housing 321. Further, in some embodiments, the aft retainer member 328 may be a plurality of pieces spaced around an outer circumference of the inner housing 322. In other embodiments, the aft retainer member 328 may be formed as an aft retainer ring, or a plurality of aft retainer ring sections that collectively form an aft retainer ring, extending around the outer circumference of the inner housing 322.

FIG. 6 is an enlarged view of a first (forward) portion VI of FIG. 5 with the diffusion plate 327 removed. As illustrated, a groove 331 is formed in the inner surface of the first wall 323 of the outer housing 321. In some embodiments, the groove 331 may be a continuous groove extending around the inner circumference of the outer housing 321. However, in other embodiments, the groove 331 may be formed as plurality of groove notches spaced around the inner circumference of the outer housing 321.

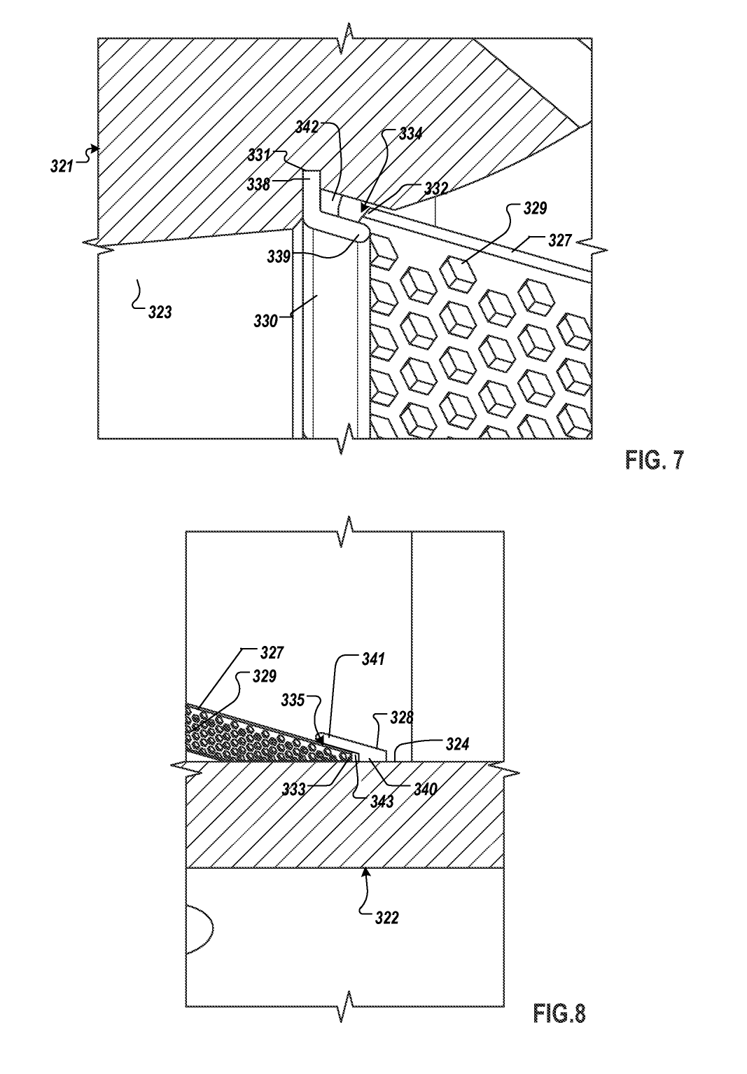

FIG. 7 is an enlarged view of a first (forward) portion VI of FIG. 5 with the forward retainer member 330 and the diffusion plate 327 installed. The forward retainer member 330 may have a generally L-shaped cross-section with a first end 338 attached to the first wall 323 and another, second end 339 extending toward the aft 337 of the diffuser 320 to retain the forward end 332 of the diffusion plate 327. As illustrated, the first end 338 of the forward retainer member 330 is inserted into the groove 331. In some embodiments, the forward retainer member 330 may welded to be retained within the groove 331. In other embodiments, different attachment mechanisms may be used such as adhesive, press fitting, or any other attachment mechanism that may be apparent to a person of ordinary skill in the art.

The second (aft) end 339 of the forward retainer member 330 extends toward the aft 337 of the diffuser 320. The aft end 339 of the forward retainer member 330 forms a forward plate receiving gap 334 with the first wall 323 of the outer housing 321. The forward end 332 of the diffusion plate 327 may be inserted and retained within this forward plate receiving gap 334. Further, an expansion buffer space 342 may be formed adjacent the forward end 332 of the diffusion plate 327 to accommodate any length changes in the diffusion plate 327 due to thermal changes within the diffuser 320 during operation of gas turbine engine 100.

FIG. 8 is an enlarged view of a second (aft) portion VIII of FIG. 5 with the diffusion plate 327 installed. As illustrated, the aft retainer member 328 may also have a generally L-shaped cross-section with a first end 340 attached to the second wall 324 and another, second end 341 extending toward the forward end 336 of the diffuser 320 to retain the aft end 333 of the diffusion plate 327. As illustrated, a first (aft) end 340 of the aft retainer member 328 may be attached to the outer surface of the second wall 324 of the inner housing 322. In some embodiments, the aft retainer member 328 may welded to the surface of the second wall 324 of the inner housing 322. In other embodiments, different attachment mechanisms may be used such as adhesive, press fitting, or any other attachment mechanism that may be apparent to a person of ordinary skill in the art.

The second (forward) end 341 of the aft retainer member 328 extends toward the forward side 336 of the diffuser 320. The forward end 341 of the aft retainer member 328 forms an aft plate receiving gap 335 with the second wall 324 of the inner housing 322. The aft end 333 of the diffusion plate 327 may be inserted and retained within this aft plate receiving gap 335. Further, an expansion buffer space 343 may be formed adjacent the aft end 333 of the diffusion plate 327 to accommodate any length changes in the diffusion plate 327 due to thermal changes within the diffuser 320 during operation of gas turbine engine 100.

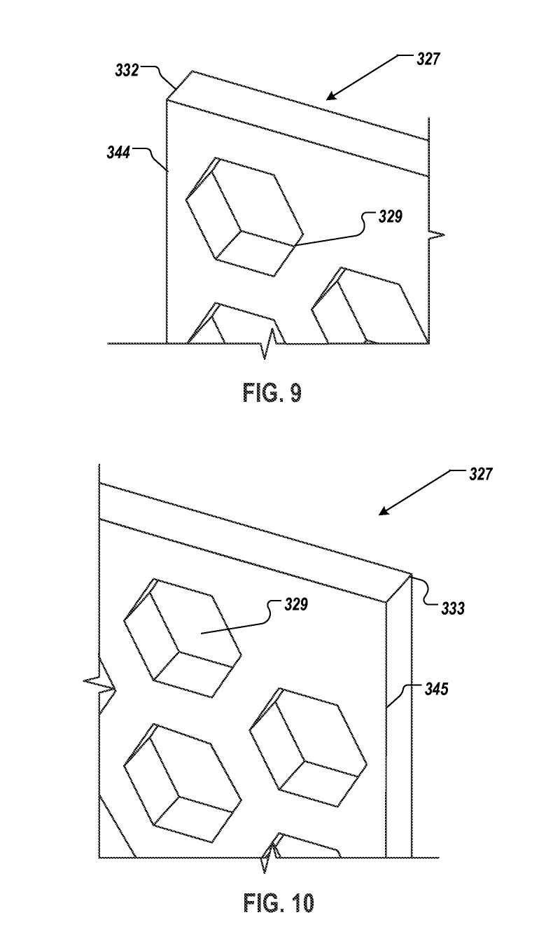

FIG. 9 is an enlarged view of a forward end 332 of the diffusion plate 327. As illustrated, the forward end 332 of the diffusion plate 327 has one or more edges 344 having right angles. However, in some embodiments, the edges 344 may be chamfered edges to assist in insertion into the forward plate receiving gap 334.

FIG. 10 in an enlarged view of an aft end 333 of the diffusion plate 327. As illustrated, the aft end 333 of the diffusion plate 327 has one or more edges 345 having right angles. However, in some embodiments, the edges 345 may be chamfered edges to assist in insertion into the aft plate receiving gap 335.

### INDUSTRIAL APPLICABILITY

Gas turbine engines, including stationary and motive gas turbine engines, and thus their components, may be suited for any number of industrial applications, such as, but not limited to, various aspects of the oil and natural gas industry (including include transmission, gathering, storage, withdrawal, and lifting of oil and natural gas), power generation industry, cogeneration, aerospace and transportation industry, to name a few examples.

Generally, embodiments of the presently disclosed gas turbine diffuser are applicable to the use, operation, maintenance, repair, and improvement of gas turbine engines, and may be used in order to improve performance and efficiency, decrease maintenance and repair, and/or lower costs. In addition, embodiments of the presently disclosed gas turbine diffuser may be applicable at any stage of the gas turbine engine's life, from design to prototyping and first manufacture, and onward to end of life. Accordingly, the gas turbine diffuser may be used in a first product, as a retrofit or enhancement to existing gas turbine engines, as a preventative measure, or even in response to an event.

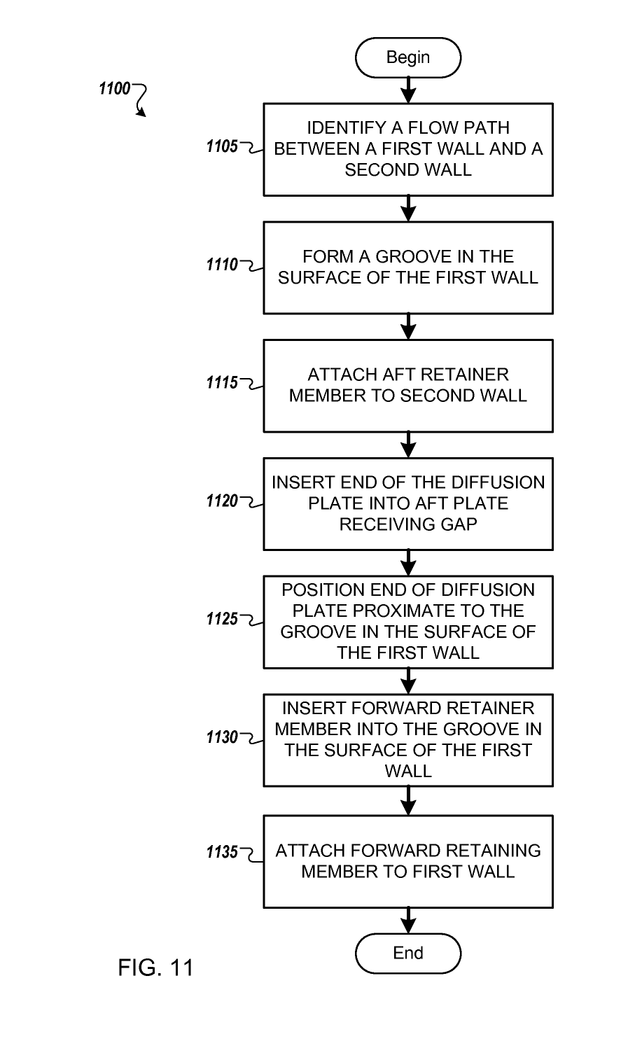

FIG. 11 is a flow chart of an exemplary method 1100 of conditioning output of the diffuser 320 output upstream of a combustor 300 in a gas turbine engine 100. In the following description, reference is made to the structures illustrated in FIGS. 1-10 for illustrative purposes. However, embodiments of this method 1100 are not limited to use with the structures illustrated in FIGS. 1-10.

In some embodiments, the method 1100 may involve retrofitting a previously assembled gas turbine engine 100 already installed on-site with a diffusion plate 327 within the diffuser 320 to condition the output and improve combustion within the combustor 300. In other embodiments, the method 1100 may correspond to installing the diffusion plate 327 within the diffuser 320 during initial assembly of the gas turbine engine 100.

The method 1100 begins with first identifying the air flow passage 326 through the diffuser 320 between a first wall 323 of a first housing 321 and a second wall 324 of a second housing 322 at 1105. Identification of the flow passage 326 is necessary to ensure proper placement of the diffusion plate 327. Once the flow passage 326 has been identified, the diffusion plate 327 must be attached to the first wall 323 of the first housing 321 and the second wall 324 of the second housing 322. In order to attach the diffusion plate 327 to the first wall 323, a groove 331 is formed in the surface of the first wall 323 in 1110. The process of forming the groove 331 is not particularly limited and may be done via cutting, grinding, milling, or any other groove forming process that may be apparent to a person of ordinary skill in the art. Further, in some embodiments, the groove 331 may be formed around an entire inner circumference of the first housing 321. In other embodiments, the groove 331 may be formed at only portions of inner circumference of the first housing 321.

After the groove 331 is formed in the surface of the first wall 323, the second (aft) end 333 is attached to the second wall 324 of the second housing 322 at an oblique angle to the flow passage 326. In order to attach the second (aft) end 333 of the diffusion plate 327 to the second wall 324, an aft retainer member 328 is attached to the second wall 324 at 1115. For example, the aft retainer member 328 may have a generally L-shaped having a first (aft) end 340 and a second (forward) end 341. The first (aft) end 340 may be attached to a surface of the second wall 324 of the second housing 322. In some embodiments, the first end 340 may be attached to the surface of the second wall 324 via a welding process. In other embodiments, the first end 340 may be attached to the surface of the second wall 324 via other attachment processes such as adhesive, press fitting, or any other attachment process that may be apparent to a person of ordinary skill in the art. When the aft retainer member 328 is attached to the second wall 324, an aft plate receiving gap 335 is formed between the second wall 324 and a second (forward) end 341 of the aft retainer member 328.

Once the aft retainer member 328 is attached to the second wall 324, an aft end 333 of the diffusion plate 327 is inserted into the aft plate receiving gap 335 at 1120. In some embodiments, the aft end 333 of the diffusion plate 327 may be positioned in the aft plate receiving gap 335 to provide an aft expansion buffer space 343 between the aft end 333 of the diffusion plate 327 and the aft retainer member 328. This aft expansion buffer space 343 may accommodate length changes (e.g. such as those due to thermal expansion) of the diffusion plate 327 during operation of the gas turbine engine 100.

After the aft end 333 of the diffusion plate 327 is inserted into the aft plate receiving gap 335, the forward end 332 of the diffusion plate 327 is positioned proximate to the groove 331 formed in the surface of the first wall 323 at 1125. By positioning the forward end 332 of the diffusion plate 327 proximate to the groove 331, the diffusion plate 327 may form an oblique angle α with respect to the second wall 324 of the second housing 322. In some embodiments, the positioning may be done manually by an assembly worker. However in other embodiments, the positioning may be done by automated assembly equipment.

Once the forward end 332 of the diffusion plate 327 is positioned proximate to the groove 331, a forward retainer member 330 is inserted into the groove 331 at 1130. For example in some embodiments, the forward retainer member 330 may have a generally L-shaped configuration and a first (forward) end 338 is inserted into the groove 331. Once the forward retainer member 330 is inserted into the groove 331, the forward retainer member 330 is attached to the first wall 323 via an attachment process at 1135. For example, in some embodiments the forward retainer member 330 may be welded to the first wall 323 near or proximate to the groove 331. In other embodiments, the forward retainer member 330 may be attached by adhesive, press fitting, or any other attachment process that may be apparent to a person of ordinary skill in the art. When the forward retainer member 330 is attached to the first wall 323, a forward plate receiving gap 334 is formed between the first wall 323 and a second (aft) end 339 of the forward retainer member 330.

As the forward end 332 of the diffusion plate 327 is positioned proximate to the groove 331 formed in the surface of the first wall 323, the forward plate receiving gap 334 is formed to surround the forward end 332 of the diffusion plate 327. In some embodiments, the forward end 332 of the diffusion plate 327 may be positioned in the forward plate receiving gap 334 to provide a forward expansion buffer space 342 between the forward end 332 of the diffusion plate 327 and the forward retainer member 330. This forward expansion buffer space 342 may accommodate length changes (e.g. such as those due to thermal expansion) of the diffusion plate 327 during operation of the gas turbine engine 100.

Once compressed air 10 leaves the compressor 200, it enters the diffuser 320. The diffuser 320 is intended to receive a compressed jet of high velocity air 10 exiting the compressor 200 and diffuse the jet into a stable and controlled flow manner and then direct air 10 towards the injectors 350. The diffuser 320 is configured to slow down and diffuse the compressed air 10, and provide the air 10 uniformly to one or more injectors 350 in the combustor case 310. However, the trajectory of the jet of air 10 exiting the compressor 200 can vary widely based on load conditions on the gas turbine engine 100. In particularly, if the jet of air 10 has a skewed profile exiting the combustor 200, the skewed velocity profile can be carried through into the injectors. These trajectory chances can affect the uniformity of air 10 flow patterns entering the injector 350 and adversely impact combustor 300 operation, as well as dissipate a majority of energy contained in the jet. These flow pattern changes and energy losses can also adversely affect engine performance and/or emissions.

The inventors have discovered through testing that inserting a diffusion plate 327 having a plurality of openings 329 oriented to intersect the flow passage 326 at the proper angle at the diffuser 320 exit may improve flow conditions entering the injector 350. In particularly, the openings 329 of the diffusion plate 327 may distribute the jet along the length of the diffusion plate 327, which can improve flow conditions entering the injectors 350 as well as reduce total combustor 300 losses. In particular, angling the diffusion plate 327 within a range of 15-45° may be beneficial to the flow conditions entering the injectors 350. Further, providing the diffusion plate 327 with openings 329 forming 50-60% of a total surface area of the diffusion plate 327 may be beneficial to the flow conditions entering the injectors 350.

Additionally, in embodiments of the diffuser 320 having struts 325, regions of flow separation may form around the struts 325 further disrupting air 10 flow into the injectors 350. By providing diffusion plates 327 as discussed above, the air 10 flow may be redistributed and flow separation around the struts 325 may be reduced or even eliminated.

As may be understood by a person of ordinary skill in the art, the angle cc of the diffusion plate 327 with respect to the second sidewall 324 of the second housing 322 and/or percentage of openings 329 formed in the diffusion plate 327 may be dependent upon one or more of diffuser geometry, flow velocity, and other flow conditions as may be apparent.

The preceding detailed description is merely exemplary in nature and is not intended to limit the invention or the application and uses of the invention. The described embodiments are not limited to use in conjunction with a particular type of gas turbine engine. Hence, although the present embodiments are, for convenience of explanation, depicted and described as being implemented in a stationary gas turbine engine, it will be appreciated that it can be implemented in various other types of gas turbine engines, and in various other systems and environments. Furthermore, there is no intention to be bound by any theory presented in any preceding section. It is also understood that the illustrations may include exaggerated dimensions and graphical representation to better illustrate the referenced items shown, and are not consider limiting unless expressly stated as such.

What is claimed is:

1. A diffuser for use in a gas turbine engine, the diffuser comprising:
an outer housing having a first wall;
an inner housing having a second wall, the inner housing being disposed within the outer housing with a flow passage formed between the first wall and the second wall and having a forward end and an aft end; and
a diffusion plate extending across the flow passage from the first wall to the second wall in an aft direction, the diffusion plate having a plurality of openings.

2. The diffuser according to claim 1, wherein the plurality of openings form 50-60% of a total surface area of the diffusion plate.

3. The diffuser according to claim 1, wherein an angle formed between the diffusion plate and the second wall is in a range between 15° and 45°.

4. The diffuser according to claim 1, further comprising:
a groove formed in an inner surface of the first wall;
a forward retainer member being inserted into the groove, the inner surface of the first wall and the forward retainer member defining a forward plate receiving gap;
the diffusion plate having a first end inserted into the forward plate receiving gap formed by the inner surface of the first wall and the forward retainer member.

5. The diffuser according to claim 4, further comprising:
an aft retainer member attached to an outer surface of the second wall, the outer surface of the second wall and the aft retainer member defining an aft plate receiving gap;
the diffusion plate having a second end inserted into the aft plate receiving gap formed by the outer surface of the second wall and the aft retainer member.

6. The diffuser according to claim 5, wherein at least one of the forward plate receiving gap and the aft plate receiving gap forming a plate expansion buffer space adjacent to at least one of the first end and the second end of the diffusion plate.

7. The diffuser according to claim 1, further comprising:
a plurality of struts connecting the inner housing to the outer housing; and
the diffusion plate includes a plurality of diffusion plates, each diffusion plates being disposed between a pair of adjacent struts of the plurality of struts.

8. A combustor for use in a gas turbine engine, the combustor including the diffuser of claim 1.

9. A gas turbine engine comprising:
a compressor;
a turbine located downstream of the compressor; and
a diffuser located downstream of the compressor and upstream of the turbine, the diffuser including
a first annular housing having a first wall having an inner surface;
a forward retainer member extending from the inner surface of the first wall, the inner surface of the first wall and the forward retainer member forming a forward plate receiving gap;
a second annular housing having a second wall having an outer surface and disposed within the first annular housing with a flow passage formed between the first wall and the second wall and having an upstream end and a downstream end;
an aft retainer member extending from the outer surface of the second wall, the inner surface of the second wall and the aft retainer member forming an aft plate receiving gap; and
a diffusion plate extending across the flow passage from the first wall to the second wall, the diffusion plate having an upstream end inserted into the forward plate receiving gap and a downstream end inserted into the aft plate receiving gap, the diffusion plate having a plurality of openings.

10. The gas turbine engine according to claim 9, further comprising:
a groove formed in the inner surface of the first wall;
the forward retainer member being inserted into the groove formed in the inner surface of the first wall.

11. The gas turbine engine according to claim 9, wherein at least one of the forward plate receiving gap and the aft plate receiving gap define a plate expansion buffer space adjacent to at least one of the upstream end and the downstream end of the diffusion plate.

12. The gas turbine engine according to claim 9, wherein the diffusion plate extends from the first wall to the second wall in a downstream direction of the diffuser and forms an angle with respect to the outer surface.

13. The gas turbine engine according to claim 12, wherein the angle between the diffusion plate and the outer surface is in a range between 15° and 45°.

14. The gas turbine engine according to claim 9, wherein the plurality of openings form 50-60% of a total surface area of the diffusion plate.

15. The gas turbine engine according to claim 9, further comprising:
a plurality of struts connecting the first annular housing to the second annular housing; and
the diffusion plate including a plurality of diffusion plate members, each diffusion plate member being disposed between a pair of adjacent struts of the plurality of struts.

16. A method of conditioning output of a diffuser upstream of a combustor in a gas turbine engine:
identifying a flow passage between a first wall of the diffuser and a second wall of the diffuser having a forward end and an aft end;
attaching a diffusion plate having a plurality of openings to the second wall of the diffuser; and
attaching the diffusion plate to the first wall of the diffuser such that the diffusion plate extends across the flow passage from the first wall to the second wall in an aft direction and forms an angle with respect to the second wall.

17. The method of claim 16, wherein the attaching the diffusion plate to the first wall comprises:
forming a groove in a surface of the first wall;
positioning a forward end of the diffusion plate proximate to the groove in the surface of the first wall;
inserting a forward retainer member into the groove formed in the surface of the first wall;
attaching the forward retainer member to the surface of the first wall to retain the forward end of the diffusion plate in a forward plate receiving gap; and
positioning the forward end of the diffusion plate within the forward plate receiving gap to provide a plate expansion buffer space between the forward end and the forward retainer member.

18. The method of claim 17, wherein the forward retainer member to the surface of the first wall comprises:
welding the forward retainer member to the surface of the first wall, proximate to the groove.

19. The method of claim 16, wherein the attaching the diffusion plate to the second wall comprises:
attaching an aft retainer member to a surface of the second wall;
inserting an aft end of the diffusion plate into an aft plate receiving gap formed by the aft retainer member and the surface of the first wall; and
positioning the aft end of the diffusion plate within the aft plate receiving gap to provide a plate expansion buffer space between the aft end and the aft retainer member.

20. The method of claim 19, wherein attaching an aft retainer member to the surface of the second wall comprises:
welding the aft retainer member to the surface of the second wall.
